(19) United States
(12) Patent Application Publication
(10) Pub. No.: US 2018/0157605 A1
(43) Pub. Date: Jun. 7, 2018

(54) CONFIGURATION OF A MEMORY CONTROLLER FOR COPY-ON-WRITE

(71) Applicant: Hewlett Packard Enterprise Development LP, Houston, TX (US)

(72) Inventors: Nigel Edwards, Bristol (GB); Chris I. Dalton, Bristol (GB); Keith Mathew McAuliffe, Houston, TX (US)

(21) Appl. No.: 15/577,895

(22) PCT Filed: Nov. 25, 2015
(86) PCT No.: PCT/US2015/062665

§ 371 Date: Nov. 29, 2017

(51) Int. Cl. G06F 13/16; G06F 21/79; G06F 21/57

(52) U.S. Cl. CPC G06F 13/1668; G06F 2201/84; G06F 21/577; G06F 21/79

(57) ABSTRACT

Examples include configuration of a memory controller for copy-on-write. Some examples include, in response to a determination to take a snapshot of memory accessible to a first component, a management subsystem configuring a memory controller to treat location IDs, mapped to initial memory locations of the accessible memory, as copy-on-write for the first component and not for a second component.

### BACKGROUND

Security issues in a computing environment may be discovered through a process of forensic analysis of the contents of the memory of the computing environment. For example, a forensic analysis process may be performed on memory of a computing device to search for security issues, such as the presence of malicious code (or “malware”). In such examples, through investigation of artifacts in the memory, such as processes running or recently run, network connections, open files, command histories, and the like, the forensic analysis process may reveal how the malware is hiding and how it is behaving.

### BRIEF DESCRIPTION OF THE DRAWINGS

The following detailed description references the drawings, wherein:

FIG. 1 is a block diagram of an example computing device to configure a memory controller for copy-on-write;

FIG. 2 is a block diagram of an example computing device having a management subsystem to configure a memory controller for copy-on-write;

FIG. 3 is a block diagram of an example computing device including an example system to configure a memory controller for copy-on-write;

FIG. 4 is a flowchart of an example method to configure a memory controller for copy-on-write; and

FIG. 5 is a flowchart of an example method to configure a memory controller for copy-on-write in response to an integrity violation.

### DETAILED DESCRIPTION

As noted above, forensic analysis for a computing device may involve analyzing the contents of the memory of the computing device to detect security issues, such as the presence of malware. In some examples, a snapshot of the contents of memory may be taken so that the snapshot may be analyzed with a forensic analysis process. In examples described herein, a “snapshot” of a portion of memory is a stored collection of the data present in the memory at a given time.

In some examples, an executing operating system (OS) or virtual machine (VM) may be paused while the snapshot is taken to obtain an accurate snapshot of the memory. However, such a pause disrupts the service provided by the OS or VM, and in some cases may be detected by malware which may evade detection in response. In other examples, a snapshot may be taken while running processes (e.g., OS, VM, or application(s)) continue to operate on the memory. Such examples may not have the drawbacks of a system pause, as described above, but may instead lead to a snapshot that includes inconsistencies or inaccuracies as the running process(es) modify the memory as the snapshot is being taken.

To address these issues, examples described herein may take a substantially instant, in-place snapshot of a portion of memory by configuring a memory controller to treat that portion of memory as copy-on-write for first component(s) that might alter the memory (e.g., when executing an OS) and not for second component(s) that are to execute a forensic analysis on the snapshot. In this manner, by configuring the memory controller in this manner, the portion of memory to be analyzed may be protected from changes, thereby creating an in-place snapshot of the memory, while allowing components that may write to the memory to continue their operation substantially without interruption by performing writes to other memory separate from the snapshot.

Examples described herein may include a computing device comprising first and second hardware components interconnected by a packet-based memory fabric, and memory accessible to the first component via a memory controller mapping, for the first and second components, location identifiers (IDs) to initial memory locations of the accessible memory. In such examples, a management subsystem may determine to take a snapshot of memory accessible to the first component, and in response may configure the memory controller to treat the location IDs as copy-on-write for the first component and not for the second component. In such examples, in response to a write packet comprising information identifying the first component as a source and indicating a given one of the location IDs for a write operation, the memory controller may create a copy-on-write mapping of the given location ID to an alternate memory location for the first component. In such examples, after creating the copy-on-write mapping and in response to a read packet comprising information identifying the second component as a source and indicating the given location ID for a read operation, the memory controller may return data stored in the initial memory location to which the given location ID is mapped for the second component.

In this manner, examples described herein may take a snapshot of memory accessible to the first component by configuring memory controller(s) managing the memory accessible to the first component as copy-on-write for the first component, thereby freezing the current content of the accessible memory while also allowing process(es) (e.g., an OS) executing at least partially on the first component to continue to operate without substantial interruption. Additionally, by enabling the second component to continue to access the initial memory locations, which will not be changed by the first component, process(es) executing at least in part on the second component (e.g., a forensic analysis system) may operate on a memory snapshot that will not be altered by any first component process(es) that continue to operate. In this manner, examples described herein may enable a memory snapshot to be taken and analyzed without a substantial pause in operating process(es) (e.g., an OS) and without introducing inconsistencies into the snapshot.

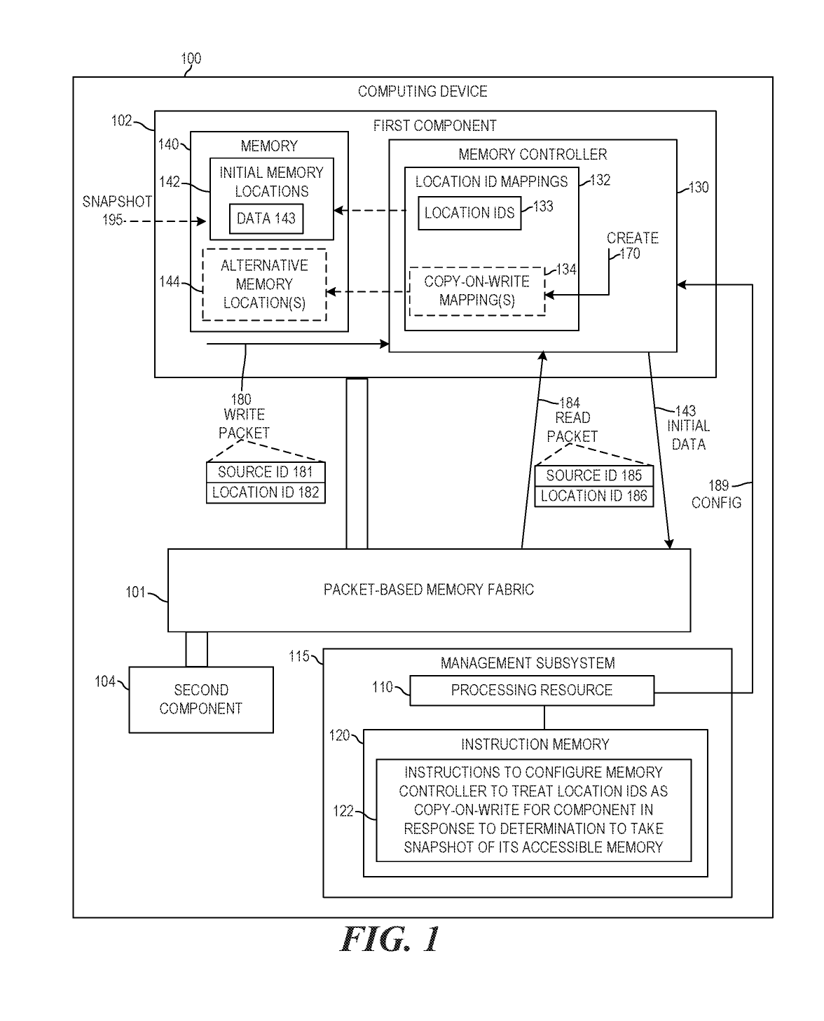

Referring now to the drawings, FIG. 1 is a block diagram of an example computing device 100 to configure a memory controller 130 for copy-on-write. Computing device 100 includes a plurality of hardware components, including a first component 102 and a second component 104. The hardware components are interconnected to communicate using a packet-based memory fabric 101.

In examples described herein, a “hardware component” (or “component”) may be a hardware device able to send packets to and receive packets form other hardware devices via the packet-based memory fabric 101. As examples, a component may be a system-on-chip (SOC) including processor core(s) and memory, a memory module including memory but excluding any processor core(s), a router to route packets in the fabric 101, a processor core (e.g., of another component), or the like.

Packet-based memory fabric 101 may interconnect components for point-to-point communication of packets, switched communication of packets, or a combination thereof. Packet-based memory fabric 101 may be implemented using wires, traces, wireless communication technologies, optical communication technologies, or the like, or a combination thereof. In examples described herein, hardware components are able to generate packets for communication on memory fabric 101, the packets including at least a component identifier (CID) that identifies the source of the packet (or sender), and an operation identifier that indicates a requested operation to be performed in response to the packet (e.g., read, write, etc.). In some examples, a packet (such as a read packet for a read operation or a write packet for a write operation) may include a location identifier (ID), such as an address, indicating a physical or logical memory address to be read from (for read packets) or written to (for write packets). For switched communication of packets, packet-based memory fabric 101 may include router(s) to route packets from source components to destination components. In such examples, a packet may include a destination CID identifying the destination component that the packet is to be routed to or otherwise provided to via memory fabric 101.

In the example of FIG. 1, computing device 100 includes a management subsystem 115 including at least one processing resource 110 and instruction memory 120 comprising instructions executable by processing resource(s) 110 to execute functionalities of the management subsystem 115 described herein. In the example of FIG. 1, instruction memory 120 includes at least instructions 122 executable by processing resource(s) 110. Management subsystem 115 may communicate with the hardware components through management channels separate from the memory fabric 101, via the packet-based memory fabric 101, or a combination thereof. In some examples, the functionalities described herein in relation to instructions of instructions memory 120 may be implemented in hardware or by a combination of hardware and programming. In examples described herein, instruction memory 120 may be implemented by at least one machine-readable storage medium.

Computing device 100 may include a memory controller 130 and associated memory 140. In examples described herein, “memory” may be implemented by at least one machine-readable storage medium, as described below. In examples described herein, a memory controller may be a hardware device or a combination of hardware and programming to mediate access to associated physical memory. A memory controller may map location IDs (e.g., logical memory addresses or locations) to physical memory locations or addresses of an associated memory (e.g., an associated memory device). In examples described herein, a memory controller may store a mapping of location IDs to memory locations in any suitable format (e.g., data structure), and may store the mapping within the memory controller, outside of but accessible to the memory controller, or a combination thereof.

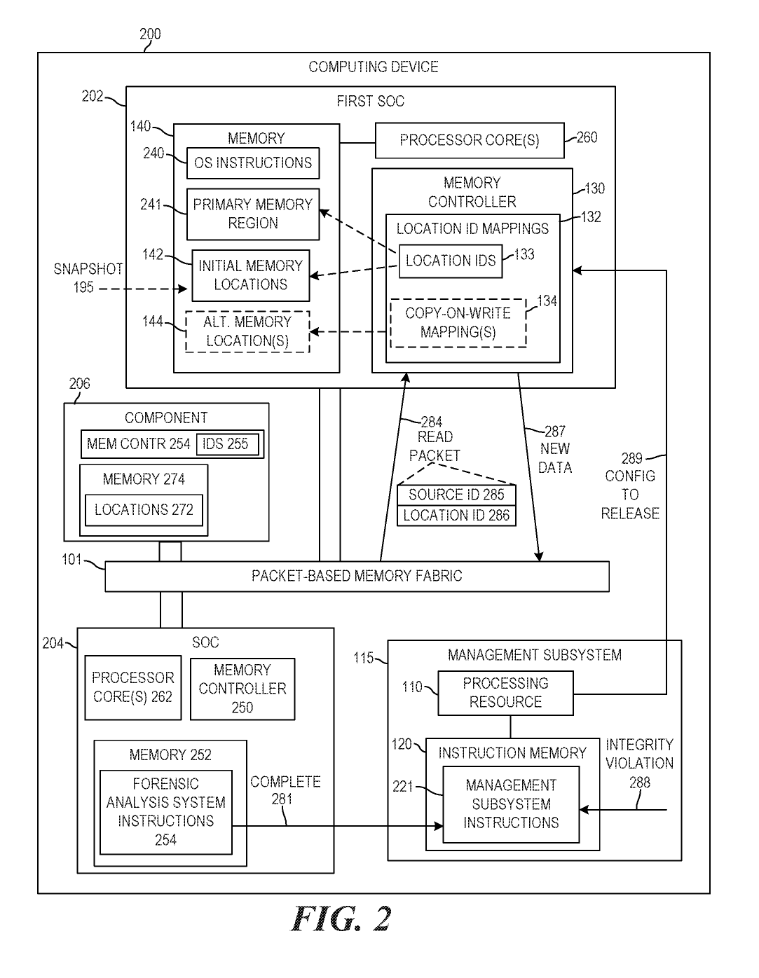

In the example of FIG. 1, first component 102 may include memory 140 and memory controller 130 to mediate access to memory 140. For example, first component 102 may be an SOC comprising processor core(s) (see FIG. 2), memory 140, and memory controller 130. In other examples, either or both of memory 140 and memory controller 130 may be separate from first and second components 102 and 104 but connected to them via memory fabric 101.

In the example of FIG. 1, management subsystem 115 may configure memory controller 130 such that at least a portion of memory 140 may be accessible to first component 102 with read-write access via memory controller 130. In the example of FIG. 1, the memory accessible to first component 102 may include initial memory locations (e.g., physical memory locations or addresses) 142, and memory controller 130 may control location ID mapping data 132 that maps location IDs 133 to the initial memory locations 142 for first component 102.

In the example of FIG. 1, instructions 122 of management subsystem 115, when executed by processing resources 110, may determine to take a snapshot of memory 142 accessible to first component 102. For example, instructions 122 may determine to take the snapshot in response to detection of an integrity violation associated with first component 102, as described below.

In response to the determination, management subsystem 115 may configure 189 memory controller 130 to treat location IDs 133 as copy-on-write for first component 102 and not for second component 104. For example, instructions 122 of management subsystem 115, when executed, may configure 189 memory controller 130 to treat location IDs 133 as copy-on-write for first component 102 and may configure 189 memory controller 130 to treat location IDs 133 as read-only for second component 104 (or as read-write for second component 104) using the present mappings of locations IDs 133 to initial memory locations 142.

In some examples, a memory controller may have an associated control data structure stored in memory that defines how the memory controller is to operate. For example, the control structure for memory controller 130 may be stored in memory 140 (or any other accessible memory), and instructions 122, when executed, may edit the control structure to configure 189 memory controller 130 to treat location IDs 133 as copy-on-write for first component 102 and as read-only for second component 104 (or as read-write for second component 104).

In examples described herein, after a memory controller is configured to treat a given location ID as copy-on-write for a given component, a first time (after the copy-on-write configuration) that a write packet including data to be written to the given location ID is received from the first component, the memory controller may create a new, copy-on-write mapping of the given location ID to an alternate memory location for the given component and write the data to the alternate memory location. In such examples, in response to subsequent read and write packets to read from or write to the given location ID, the memory controller may use the copy-on-write mapping to the alternate memory location to perform the read or write operation.

In the example of FIG. 1, memory controller 130, configured to treat location IDs 133 as copy-on-write for first component 102, may receive a write packet 180 comprising information 181 (e.g., a CID) identifying first component 102 as a source of write packet 180 and also including information 182 specifying a given one of location IDs 133 for the performance of a write operation. In such examples, in response to write packet 180, memory controller 130 configured to treat the given location ID 133 as copy-on-write for the first component 102 may determine whether it has already created a copy-on-write mapping for the given location ID 133. When it has not, memory controller 130 may, in response to packet 180, create 170 a new copy-on-write mapping 134 of the given location ID 133 to an alternative memory location for the first component, and write data specified in the packet 180 to the alternative memory location. In such examples, to create the new copy-on-write mapping, memory controller 130 may allocate an available alternative memory location 144 in memory 140, and write mapping data (e.g., to a data structure) to map the given location ID 133 to the allocated alternative memory location 144 for first component 102.

In such examples, though a new copy-on-write mapping of the given location ID 133 is created for first component 102, memory controller 130 maintains the prior mapping of the given location ID 133 to a respective one of initial memory locations 142 for the second component 104 in the location ID mapping data 132. In such examples, the location mapping data 132 includes information specifying the different mappings of the given location ID 133 for the first and second components as packet sources.

In such examples, after the copy-on-write mapping 134 for the given location ID 133 is created for first component 102, memory controller 130 may receive a read packet 184 comprising information 185 (e.g., a CID) identifying second component 104 as a source of the read packet 184 and including information 186 indicating the given location ID 133 for the performance of a read operation. In such examples, in response to read packet 184, memory controller 130 (configured to treat the given location ID 133 as read-only or read-write for the second component 104) may return initial data 143 stored in the initial memory location 142 to which the given location ID 133 is mapped for second component.

In such examples, to return the initial data 143, memory controller 130 may access the mapping for the given location ID 133 for second component 104 to determine an initial memory location 142 to which it is mapped, read initial data 143 from the determined initial memory location 142, and provide the initial data 143 back to the second component in a packet via memory fabric 101. In some examples, the initial data 143 may be the data stored in initial memory locations 142 at the time that memory controller 130 was configured for copy-on-write for first component 102.

Although a single example of copy-on-write for first component 102 is described above, memory controller 130, configured for copy-on-write for first component 102, may similarly treat other write packets from first component 102. For example, in response to each write packet comprising information identifying first component 102 as a source and information indicating, for a write operation, a respective one of location IDs 133 not already given a copy-on-write mapping, memory controller 130 (configured for copy-on-write) may create 170 a copy-on-write mapping of location ID 133 to a respective alternate memory location 144 for first component 102 and write respective new data (in the write packet) to the alternative memory location 144, as described above.

Although a single example read for second component 104 is described above, memory controller 130, configured for copy-on-write for first component 102, may similarly treat other read packets from second component 104. For example, in response to each read packet comprising information identifying second component 104 as a source and information indicating, for a read operation, one of location IDs 133, memory controller 130 (configured for copy-on-write) may return initial data 143 stored in the initial memory location 142 to which location ID 133 is mapped for second component 104. In such examples, memory controller 130 may return the initial data 143 in response, regardless of whether a copy-on-write mapping 134 for first component 104 was created for the location ID 133.

In examples described herein, by configuring memory controller 130 to treat location IDs 133 as copy-on-write for first component 102 and read-only or read-write for second component 104, examples described herein may enable a substantially instant, in-place snapshot 195 of the memory locations that location IDs 133 are mapped to, without pausing process(es) executed by first component 102 (e.g., an OS) and without altering the data in the snapshot 195, which may be read unaltered by second component 104 (which may perform a forensic analysis, for example). In such examples, after configuring memory controller 130 to treat location IDs 133 as copy-on-write for first component 102 and read-only or read-write for second component 104, computing device 100 may execute simultaneously at least a portion of an OS with first component 102 and at least a portion of a forensic analysis system with second component 104, without modifying the snapshot 195 comprising initial data 143 stored in initial memory locations 142 at the time of the configuration, and with each of first and second components 102 and 104 attempting to access initial physical memory locations 142 using location IDs 133. In such examples, by using the management subsystem 115 to configure memory controller 130 as described above to take the snapshot 195, the snapshot 195 may be taken in a manner that is transparent to first component 102, which may continue to use the same location IDs (e.g., addresses) to access memory as before the snapshot was taken. In this manner, the fact of the snapshot 195 being taken may be hidden from the first component, the OS it may be at least partially executing, and thus from any potential malware. In examples described herein, execution of an operating system may include execution of the operating system itself and any number of processes of or associated with the operating system. In examples in which component(s) are said to execute (or be assigned to execute) an OS, the component(s) may execute (or be assigned to execute) the OS and any number of processes of or associated with the OS.

In examples described herein, a component may be associated with one CID, or a plurality of CIDs. In examples in which a component is associated with a plurality of CIDs, any of the CIDs associated with the component may identify the component as the source of a packet. For example, for a component that is an SOC, a different CID may be assigned to each processor core of the SOC. In such examples, any of the CIDs assigned to processor cores of the SOC may identify the SOC as the source. In such examples, to configure a memory controller as copy-on-write for such an SOC, the memory controller may be configured as copy-on-write for all of the CIDs of the processor cores of the SOC. In some examples, these CIDs may be treated as a group such that a copy-on-write mapping, created in response to a packet identifying one of these CIDs as a source, is stored and used for all of the CIDs associated with the SOC.

Although examples have been described above in relation to memory accessible via one memory controller, in other examples, memory accessible to a first component 102 for which a snapshot is to be taken may be distributed across a plurality of components. In such examples, for each memory controller mediating access to a portion of the memory for which a snapshot is to be taken, management subsystem 115 may configure the memory controller for copy-on-write for the portion of memory for the first component, as described above, and configure the memory controller for read-only or read-write access for another component (e.g., to execute forensic analysis). In such examples, the snapshot may be released by management subsystem 115 performing a release process (described below) at each memory controller configured for copy-on-write to take the snapshot.

As used herein, a “computing device” may be a desktop computer, laptop (or notebook) computer, workstation, tablet computer, mobile phone, smart device, switch, router, server, blade enclosure, or any other processing device or equipment including a processing resource. In examples described herein, a processing resource may include, for example, one processor (or processor core) or multiple processors (or processor cores) included in a single device or distributed across multiple devices.

As used herein, a “processor” or “processor core” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 110 may fetch, decode, and execute instructions stored on storage medium 120 to perform the functionalities described herein.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

In examples described herein, combinations of hardware and programming may be implemented in a number of different ways. For example, the programming may be processor executable instructions stored on at least one non-transitory machine-readable storage medium and the hardware may include at least one processing resource to execute those instructions. In some examples, the hardware may also include other electronic circuitry. In some examples, functionalities described herein in relation to FIG. 1 may be provided in combination with functionalities described herein in relation to any of FIGS. 2-5.

Further examples are described herein in relation to FIG. 2. FIG. 2 is a block diagram of example computing device 200 having a management subsystem 115 to configure memory controller 130 for copy-on-write. In the example of FIG. 2, computing device 200 may include a management subsystem 115 and a packet-based memory fabric 101, each as described above in relation to FIG. 1. In the example of FIG. 2, instruction memory 120 may include management subsystem instructions 221, which may include instructions 122 described above in relation to FIG. 1. Instructions 221 may also include additional instructions.

In the example of FIG. 2, computing device 200 may include a first SOC 202 and a second SOC 204. First SOC 202 may include memory 140 and memory controller 130, each as described above in relation to FIG. 1, and may include at least one processor core 260. In the example of FIG. 2, memory 140 may include OS instructions 240 executable by core(s) 260 to execute at least a portion of an OS. Second SOC 204 may include memory 252, a memory controller 250 for at least memory 252, and at least one processor core 262. Memory 252 may be implemented by at least one machine-readable storage medium, and may store instructions 254 executable by core(s) 262 to execute at least a portion of a forensic analysis system. In the example of FIG. 2, computing device 200 may include a component 206 (e.g., SOC, memory module, etc.) comprising at least memory 274 (implemented by at least one machine-readable storage medium) and a memory controller 254 mapping location IDs 255 to initial memory locations 272 of memory 274.

In the example of FIG. 2, instructions 221, when executed by processing resource 110, may monitor for integrity violations in computing device 200, such as kernel integrity violations for the OS executed at least in part by core(s) 260 (e.g., changed code, etc.). In some example, instructions 221 may detect 288 an integrity violation associated with first SOC 202, and may determine to take a snapshot of memory 142 accessible to first SOC 202 in response.

In response to the determination to take a snapshot of memory 142 accessible to first SOC 202, instructions 221, when executed, may configure memory controller 130 to treat location IDs 133, mapped to initial memory locations 142 storing initial data 143 (see FIG. 1), as copy-on-write for first SOC 202 and as read-only or read-write for second SOC 204, as described above in relation to FIG. 1.

With the memory controller 130 configured for copy-on-write for first SOC 202, as described, in response to each write packet comprising information identifying first SOC 202 as a source and indicating, for a write operation, a respective one of location IDs 133 not already given a copy-on-write mapping, memory controller 130 may create a copy-on-write mapping 134 of location ID 133 to a respective alternate memory location 144 for first SOC 202 and write respective new data to alternative memory location 144, as described above.

In such examples, with the memory controller 130 configured for copy-on-write for second SOC 204, in response to each read packet comprising information identifying second SOC 204 as a source and indicating, for a read operation, one of location IDs 133, memory controller 130 may return initial data 143 stored in the initial memory location 142 to which the location ID 133 is mapped for second SOC, as described above.

In examples described herein, after a memory controller creates a copy-on-write mapping for a location ID for a given component, the memory controller is to use the copy-on-write mapping for subsequent reads from and writes to that location ID for the given component. For example, in the example of FIG. 2, memory controller 130, configured to treat location IDs 133 as copy-on-write for first SOC 202, may receive a read packet 284 comprising information 285 (e.g., a CID) identifying first SOC 202 as a source and information 286 indicating, for a read operation, a given one of the location IDs 133 previously given a copy-on-write mapping. In such examples, in response to read packet 284, memory controller 130 may return the respective new data 287 stored in the respective alternate memory location 144 to which the location ID 133 was mapped for first SOC 202. In such examples, to return the new data, memory controller 130 may access the copy-on-write mapping 134 for the given location ID 133 for first SOC 202 (e.g., for any of the CIDs associated with first SOC 202) to determine the alternative memory location 144 to which it is mapped, read the new data from the determined alternative memory location 144, and provide the new data back to first SOC 202.

In such examples, after configuring memory controller 130 to treat location IDs 133 as copy-on-write for first SOC 202 and as read-only (or read-write) for second SOC 204 to take a snapshot 195 of the memory 142 accessible to first SOC 202, first SOC 202 may execute at least a portion of the OS while the second SOC is to simultaneously execute at least a portion of the forensic analysis system, including the first and second SOCs each attempting to access multiple of the initial physical memory locations 142 using location IDs 133. In such examples, the configuration of memory controller 130 allows first SOC 202 to continue to operate and perform writes that do not change the snapshot 195 (in a manner that is transparent to first SOC 202 and the OS) and allows second SOC 204 to perform forensic analysis on the snapshot 195 without pausing the OS.

The forensic analysis system executed at least in part by second SOC 204 may perform any suitable forensic analysis on the snapshot 195. For example, the forensic analysis system may scan the snapshot 195 to search for indicators of compromise (IOCs), patterns that indicate malicious behavior, data structure(s) open to a known malicious site, network connections to a suspect location, presence of a known malicious code package, suspect changes in the memory over time, or the like, or a combination thereof.

In some examples, the forensic analysis system may indicate 281 to the management subsystem that a particular portion of the forensic analysis system is complete such that the snapshot 195 of initial memory locations 142 may be released. In some examples, the forensic analysis system may copy the data of the snapshot 195, stored in initial memory locations 142, to other, secondary memory locations for analysis in the secondary memory locations. In such examples, once the copying is complete, the snapshot 195 may be released and the copy-on-write configuration may be lifted. In such examples, the forensic analysis system may indicate 281 to the management subsystem 115 that the process of copying is complete. In response, instructions 221, when executed, may determine to release the snapshot 195.

In other examples, the forensic analysis system may perform the analysis on the snapshot 195 in place in the initial memory locations 142, and provide an indication 281 to the management subsystem that the forensic analysis of the data of the snapshot 195 stored in the initial memory locations 142 is complete. In such examples, in response to the indication 281, instructions 221, when executed, may determine to release the snapshot 195.

In response to determining to release the snapshot 195, instructions 221 of management subsystem 115 may be executed to release the snapshot 195. In some examples, releasing the snapshot 195 may include instructions 221, when executed, configuring 289 memory controller 130 to provide, for first SOC 202, read-write access for location IDs 133 for which no copy-on-write mapping was created, thereby allowing such the corresponding initial memory locations 142 to be read and written by first SOC 202 again. Releasing the snapshot 195 may also include instructions 221, when executed, for each copy-on-write mapping 134 of one of location IDs 133 to an alternate memory location 134 created for first SOC 202, mapping the location ID 133 to the alternate memory location 144 for second SOC 204, and freeing (for reuse by memory controller 130) the initial memory location 142 to which the location ID 133 was previously mapped, by instructions 221, when executed.

Although examples have been described above in relation to memory accessible via one memory controller, in other examples, memory accessible to a first SOC 202 (or other component) for which a snapshot is to be taken may be distributed across a plurality of components. In such examples, as described above, for each memory controller mediating access to a portion of the memory for which a snapshot is to be taken, management subsystem 115 may configure the memory controller for copy-on-write for the portion of memory, as described above. In such examples, the snapshot may be released by management subsystem 115 performing a release process at each memory controller configured for copy-on-write to take the snapshot.

For example, in addition to initial memory locations 142, initial memory locations 272 may be accessible to first SOC 202 via memory controller 254. In such examples, in response to the determination to take a snapshot of memory accessible to first SOC 202, instructions 221, when executed, may configure memory controller 130 as describe above and may configure memory controller 254 to treat location IDs 255 (mapped to initial memory locations 272), as copy-on-write for first SOC 202 and as read-only for second SOC 204 (or as read-write for second SOC 204), as described above in relation to FIG. 1.

In such examples, memory controller 254, configured for copy-on-write for first SOC 202, may receive a write packet comprising information (e.g., a CID) identifying first SOC 202 as a source of the packet and information indicating, for a write operation, a given one of location IDs 255 not already given a copy-on-write mapping. In response to such a write packet, memory controller 254, configured for copy-on-write for first SOC 202, may create a copy-on-write mapping of the given location ID to a respective different memory location (e.g., in memory 274) for the first SOC 202, as described above in relation to memory controller 130. Although handling of one example packet is described, memory controller 254, configured for copy-on-write for first SOC 202, may similarly treat other write packets from first SOC 202.

In such examples, memory controller 254 may receive a read packet comprising information identifying the second SOC 204 as a source of the packet and information indicating, for a read operation, the given one of the location IDs 255. In response to such a read packet, memory controller 254, configured for copy-on-write for first SOC 202 and read-only or read-write for second SOC 204, may return data stored in the initial memory location 272 to which the given location ID 255 is mapped for second SOC 204, as described above in relation to memory controller 130. Although handling of one example packet is described, memory controller 254, configured for read-only or read-write access for second SOC 204, may similarly treat other read packets from second SOC 204.

In an example described above, management subsystem is to configure two memory controllers to thereby take a snapshot involving memory in two separate components of computing device 200. In other examples, memory accessible to a first component (e.g., SOC) may be distributed across any number of components of computing device 200 connected by packet-based memory fabric 101, and may be accessed via any number of memory controllers. In such examples, in response to a determination to take a snapshot of memory accessible to the first component, instructions 221 of management subsystem 115, when executed, may configure each of the memory controllers mediating a portion of the accessible memory to treat locations IDs as copy-on-write for the first component and as read-only or read-write for a second component (e.g., SOC), as described above in relation to FIGS. 1 and 2. In such examples, management subsystem 115 may take a substantially instant, in-place snapshot of the memory accessible to the first component, for memory that is distributed in various components of computing device 200 connected by memory fabric 101 and is accessed via various different memory controllers. In such examples, the snapshot may be released by performing the release process described above for each of the involved memory controllers.

In some examples, memory controllers for memory accessible to the first component may maintain the accessible memory as a mirror (or duplicate) of other memory of computing device 200. In such examples, the snapshot may be taken, as described above, for the mirror or duplicate memory and not for the other (primary) memory.

As an example, memory controller 130 may maintain the accessible memory 142 as a mirror of a primary region of memory 241 different than the accessible memory 142, using location IDs 133 for the accessible memory 142 and primary memory region 241. In such examples, memory controller 130 may transparently perform the mirroring by mapping each location ID 133 to an initial memory location 142 and another memory location in primary memory region 241, and applying each operation targeting a location ID 133 to each of the mapped memory locations. In such examples, in response to a determination to snapshot the memory accessible to first SOC 202, instructions 221, when executed, may configure memory controller 130 to treat location IDs 133 as copy-on-write for the first SOC 202 for the initial memory locations 142, and may pause the mirroring of location IDs 133 to the primary memory region 241, ceasing writes to primary memory region 241 (and not configuring the location IDs 133 as copy-on-write for the first SOC for the primary region of memory 241). In this manner, after the configuration for copy-on-write, management subsystem 115 may treat the information in the primary memory region 241 as the snapshot (e.g., for forensic analysis by SOC 204), and process(es) executed at least in part by first SOC 202 (e.g., an OS) may continue to operate using the location IDs 133 for reads and writes of initial memory location 142, while applying copy-on-write, as described above, to prevent changes to the initial data stored in initial memory locations 142. In such examples, in releasing the snapshot, management system 115 may resume the mirroring by performing the release process described above for both the initial memory locations 142 and the primary memory region 241. In such examples, management system 115 may use alternative memory locations 144 from any copy-on-write operations to update the mappings of location IDs 133 for which copy-on-write operations were performed, for both the initial memory locations 142 and the primary memory region 241, thereby reconciling the contents of the two memory regions. Management subsystem 115 may restore read-write access to both updated regions such that the mirroring resumes as before the snapshot. In some examples, functionalities described herein in relation to FIG. 2 may be provided in combination with functionalities described herein in relation to any of FIGS. 1 and 3-5.

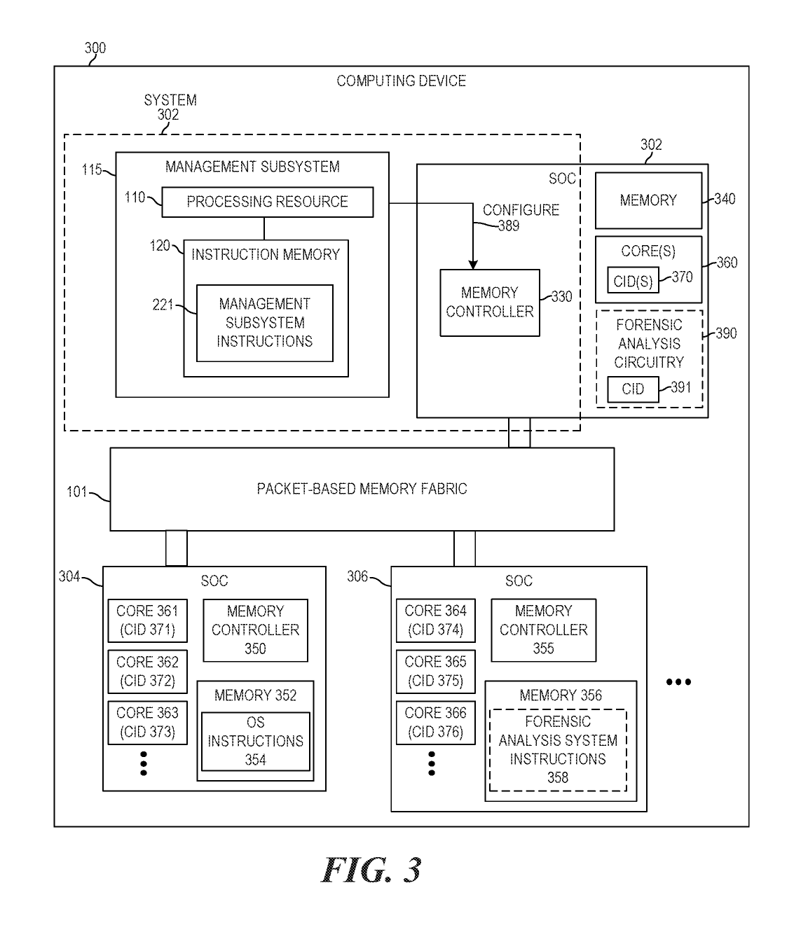

FIG. 3 is a block diagram of an example computing device 300 including an example system 302 to configure a memory controller for copy-on-write. Computing device 300 includes a plurality of hardware components interconnected to communicate using a packet-based memory fabric 101, as described above.

In the example of FIG. 3, the components may include an SOC 302 including other component(s), such as processor core(s) 360 assigned CID(s) 370. SOC 302 may include memory 340. The components may also include an SOC 304 including a plurality of components, such as at least processor cores 361-363 assigned CIDs 371-373, respectively. SOC 304 may include memory 352 and a memory controller 350. The components may also include an SOC 306 including a plurality of components, such as at least processor cores 364-366 assigned CIDs 374-376, respectively. SOC 306 may include memory 356 and a memory controller 355.

In the example of FIG. 3, system 302 comprises a memory controller 330 of the plurality of hardware components. In the example of FIG. 3, the memory controller 330 may be part of SOC 302. In other examples, memory controller 330 may be part of another type of component, such as a memory module. System 302 also includes a management subsystem 115, as described above in relation to FIGS. 1 and 2.

In the example of FIG. 3, different hardware components of computing device 300 may be assigned to execute different processes. For example, different cores among at least cores 360-366 of computing device 300 may be assigned to execute at least a portion of an OS of computing device 300, while other cores among at least cores 360-366 may be assigned to execute a forensic analysis system.

As an example, a first set of processor cores 360-363 may be assigned to execute at least a portion of an OS, such as by executing OS instructions from memory. In such examples, core 360 may execute instructions from memory 340 and cores 361-363 may execute OS instructions 354 from memory 352. In such examples, cores 360-363 may form a first set of components to execute at least a portion of an OS, and the CIDs 370-373 of cores 360-363 may form a first set of CIDs. In such examples, second set of processor cores 364-366 may be assigned to execute at least a portion of a forensic analysis system, such as by executing forensic analysis system instructions 358 from memory 356. In such examples, cores 364-366 may form a second set of components to execute a forensic analysis system, and the CIDs 374-376 of cores 364-366 may form a second set of CIDs. This example division into first and second sets of components and CIDs is an example for explanatory purposes in relation to FIG. 3. In other examples, other divisions may be made.

In the example of FIG. 3, the memory controller 330 may map location IDs for memory 340 to initial memory locations of memory 340 accessible to the first set of components. As described above, instructions 221 of management subsystem 115, when executed, may determine to take a snapshot of the memory accessible to the first components, which includes at least portions of memory 340. In response to the determination, instructions 221, when executed, may configure 389 memory controller 330 to treat the location IDs mapped to the accessible memory as copy-on-write for sources identified by the first CIDs, respectively, and as read-only or read-write for at least one source identified by any second CID. Instructions 221 may configure memory controller 330 as described above for memory controller 130.

In such examples, memory controller 330 may receive a write packet comprising, for a write operation, one of the location IDs not already given a copy-on-write mapping and one of the first CIDs as a source identifier. In response, memory controller 330, configured for copy-on-write for first CIDs, may create a copy-on-write mapping of the location ID to a respective alternate memory location (e.g., in memory 340 or elsewhere) for sources identified by the first CIDs. In such examples, memory controller 330 may receive a read packet comprising, for a read operation, one of the location IDs and one of the second CID(s) as a source identifier. In response, memory controller 330 (configured for copy-on-write for first CIDs), may return data stored in the initial memory location to which the location ID is mapped for the second CID. Although a single example of copy-on-write for the first components is described above, memory controller 330, configured for copy-on-write for the first component, may similarly treat other write packets from first components (e.g., including first CID(S) as source identifiers). Also, although a single example read for a second component is described above, memory controller 330, when configured for copy-on-write for first component 102, may similarly treat other read packets from second component(s) (i.e., including second CID(s) as source identifiers).

In this manner, to take a snapshot, management subsystem 115 may configure memory controller 330 to treat location IDs as copy-on-write for components associated with the first CIDs (i.e., assigned to execute an at least a portion of an OS), and may configure memory controller 330 to treat location IDs as read-only or read-write for components associated with second CID(s) (i.e., assigned to execute at least a portion of a forensic analysis system). In some examples, system 302 may include the first and second sets of processor cores.

In other examples, a second CID (i.e., CID 391), not included in the first set of CIDs, may be assigned to forensic analysis circuitry 390 to perform forensic analysis on the snapshot. In such examples, the forensic analysis circuitry may comprise at least one of an application-specific integrated circuit (ASIC) and a field-programmable gate array (FPGA) to perform a forensic analysis as described above.

In such examples, in response to a determination to take a snapshot of the memory accessible to the first components, which includes at least portions of memory 340, instructions 221 of management subsystem 115, when executed, may configure memory controller 330 to treat the location IDs mapped to the accessible memory as copy-on-write for sources identified by the first CIDs, respectively, and as read-only or read-write for a source identified by the second CID, which in this example, may be forensic analysis circuitry 390. In this manner, while memory controller 330 is configured to treat location IDs as copy-on-write for components associated with the first CIDs (i.e., assigned to execute an at least a portion of an OS), memory controller 330 is configured to treat location IDs as read-only or read-write for forensic analysis circuitry 390 associated with second CID 391, such that the forensic analysis circuitry is able to read and perform forensic analysis on the data in the snapshot without the first components being paused in their execution or altering the data of the snapshot. In some examples, system 302 may include the first components and forensic analysis circuitry 391.

Although examples have been described above in relation to memory accessible via one memory controller, in other examples, memory accessible to a first component 102 for which a snapshot is to be taken may be distributed across a plurality of components. In such examples, for each memory controller mediating access to a portion of the memory for which a snapshot is to be taken, management subsystem 115 may configure the memory controller for copy-on-write for the portion of memory for the first components, as described above, and configure the memory controller for read-only or read-write access for other component(s) (e.g., to execute forensic analysis). In such examples, the snapshot may be released by management subsystem 115 performing a release process (described above) at each memory controller configured for copy-on-write to take the snapshot.

In the example of FIG. 3, computing device 330 includes SOCs 302, 304, and 306. In other examples, computing device 300 may include other types of component(s) (e.g., memory modules including memory controllers) in addition to SOCs, or in place of at least one of the SOCs. For example, component 302 may be a memory module including memory controller 330, memory 340, and forensic analysis circuitry 390. In some examples, functionalities described herein in relation to FIG. 3 may be provided in combination with functionalities described herein in relation to any of FIGS. 1-2 and 4-5.

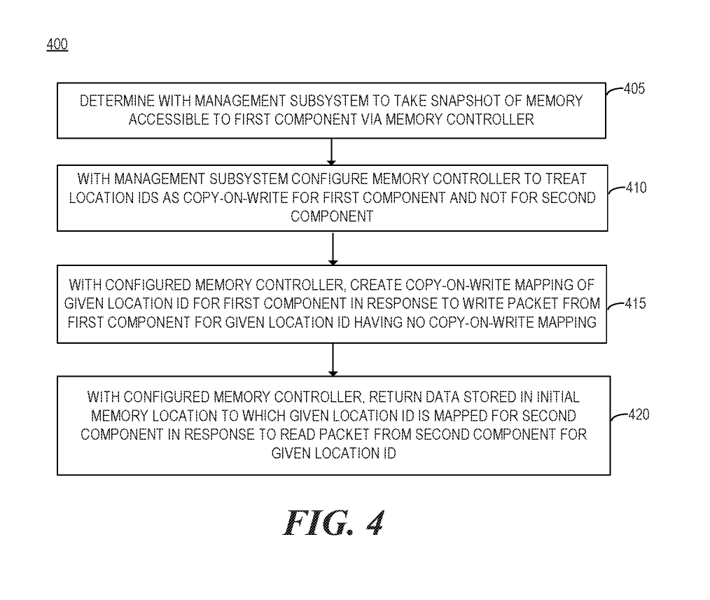

FIG. 4 is a flowchart of an example method 400 to configure a memory controller for copy-on-write. Although execution of method 400 is described below with reference to computing device 100 as described above in relation to FIG. 1, other suitable systems for the execution of method 400 can be utilized (e.g., computing device 200 of FIG. 2 or 300 of FIG. 3). Additionally, implementation of method 400 is not limited to such examples.

As described above, computing device 100 comprises first and second hardware components 102 and 104 interconnected by a packet-based memory fabric 101. At 405 of method 400, instructions 122 of management subsystem, when executed, may determine to take a snapshot of memory accessible to first component 102 via a memory controller 130. As described above, memory controller 130 may map location IDs 133 to initial memory locations 142 of the accessible memory for first component 102. At 410, in response to the determination, instructions 122 of management subsystem 115, when executed, may configure memory controller 130 to treat the location IDs 133 as copy-on-write for the first component and not for the second component. In such examples, instructions 221 may configure memory controller 130 to treat location IDs 133 as read-only or read-write for the second component.

At 415, memory controller 130, configured for copy-on-write, as described above, in response to a write packet comprising information identifying first component 102 as a source and indicating, for a write operation, a given one of the location IDs 133 for which a copy-on-write mapping was not already created for the first component, may create a copy-on-write mapping 134 of the given location ID 133 to an alternate memory location 144 for first component 120.

At 420, memory controller 130, configured for copy-on-write, as described above, after creating the copy-on-write mapping 134 and in response to a read packet comprising information identifying second component 104 as a source and indicating, for a read operation, the given location ID 133, may return data 143 stored in initial memory location 142 to which the given location ID 133 is mapped for second component 104.

Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. Although examples have been described above in relation a first component provided copy-on-write access and a second component provided read-only or read-write access via a memory controller, other examples, one or a plurality of first components may be provided copy-on-write access, as described above, by one or a plurality of different memory controllers, and one or a plurality of second components may be provided read-only or read-write access, as described above, by one or a plurality of different memory controllers. In some examples, functionalities described herein in relation to FIG. 4 may be provided in combination with functionalities described herein in relation to any of FIGS. 1-3 and 5.

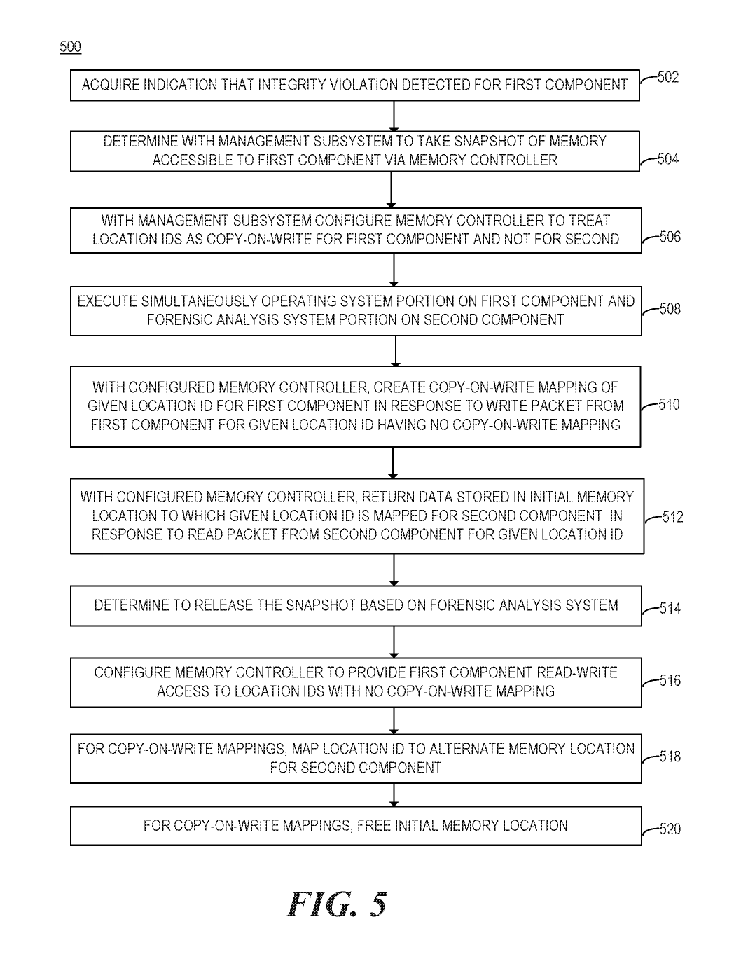

FIG. 5 is a flowchart of an example method 500 to configure a memory controller for copy-on-write in response to an integrity violation. Although execution of method 500 is described below with reference to computing device 100 as described above in relation to FIG. 1, other suitable systems for the execution of method 500 can be utilized (e.g., computing device 200 of FIG. 2 or computing device 300 of FIG. 3). Additionally, implementation of method 500 is not limited to such examples.

As described above, computing device 100 comprises first and second hardware components 102 and 104 interconnected by a packet-based memory fabric 101. At 502 of method 500, management subsystem 115 may detect an integrity violation associated with first component 102 of the computing device (see FIG. 2). At 504, instructions 122 of management subsystem, when executed, may determine to take a snapshot 195 of memory accessible to first component 102 via a memory controller 130 in response to detection of the integrity violation. As described above, memory controller 130 may map location IDs 133 to initial memory locations 142 of the accessible memory for first component 102.

At 506, in response to the determination, instructions 122 of management subsystem 115, when executed, may configure memory controller 130 to treat the location IDs 133 as copy-on-write for the first component and not for the second component. In such examples, instructions 221 may configure memory controller 130 to treat location IDs 133 as read-only or read-write for the second component.

At 508, after configuring memory controller 130, computing device 100 may execute simultaneously at least a portion of an OS with first component 102 and at least a portion of a forensic analysis system with second component 104, without modifying the snapshot comprising initial data stored in the initial memory locations at the time of the configuration, and with each of the first and second components attempting to access multiple of the initial physical memory locations using the location IDs.

At 510, memory controller 130, configured for copy-on-write, as described above, in response to a write packet comprising information identifying first component 102 as a source and indicating, for a write operation, a given one of the location IDs 133 for which a copy-on-write mapping was not already created for the first component, may create a copy-on-write mapping 134 of the given location ID 133 to an alternate memory location 144 for first component 120.

At 512, memory controller 130, configured for copy-on-write, as described above, after creating the copy-on-write mapping 134 and in response to a read packet comprising information identifying second component 104 as a source and indicating, for a read operation, the given location ID 133, may return data 143 stored in initial memory location 142 to which the given location ID 133 is mapped for second component 104.

At 514, management subsystem 115 may determine to release the snapshot 195, as described above. In some examples, management subsystem 115 may determine to release the snapshot 195 in response to an indication that the forensic analysis system has completed a process of copying the data of the snapshot or in response to an indication that the forensic analysis system has completed a forensic analysis of the data of the snapshot.

In response to the determination to release snapshot 195, at 516, management subsystem 115 may configure memory controller 130 to provide, for first component 120, read-write access for location IDs 133 for which no copy-on-write mapping was created. At 518, for each copy-on-write mapping of one of the location IDs 133 to an alternate memory location 144 created for first component 120, management subsystem 115 may map the location ID 133 to the alternate memory location 144 for second component 104.

At 520, for each copy-on-write mapping of one of the location IDs 133 to an alternate memory location 144 created for first component 120, management subsystem 115 may free the initial memory location 142 to which the location ID 133 was previously mapped.

Although the flowchart of FIG. 5 shows a specific order of performance of certain functionalities, method 500 is not limited to that order. For example, the functionalities shown in succession in the flowchart may be performed in a different order, may be executed concurrently or with partial concurrence, or a combination thereof. Although examples have been described above in relation a first component provided copy-on-write access and a second component provided read-only or read-write access via a memory controller, other examples, one or a plurality of first components may be provided copy-on-write access, as described above, by one or a plurality of different memory controllers, and one or a plurality of second components may be provided read-only or read-write access, as described above, by one or a plurality of different memory controllers. In some examples, functionalities described herein in relation to FIG. 5 may be provided in combination with functionalities described herein in relation to any of FIGS. 1-4.

All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. A method of a computing device comprising first and second hardware components interconnected by a packet-based memory fabric, the method comprising:
determining, with a management subsystem, to take a snapshot of memory accessible to the first component via a memory controller, and the memory controller mapping location identifiers (IDs) to initial memory locations of the accessible memory for the first component;
in response to the determination, with the management subsystem, configuring the memory controller to treat the location IDs as copy-on-write for the first component and not for the second component;
with the memory controller configured for copy-on-write:
in response to a write packet comprising information identifying the first component as a source and indicating, for a write operation, a given one of the location IDs for which a copy-on-write mapping was not already created for the first component, create a copy-on-write mapping of the given location ID to an alternate memory location for the first component; and
after creating the copy-on-write mapping and in response to a read packet comprising information identifying the second component as a source and indicating, for a read operation, the given location ID, returning data stored in the initial memory location to which the given location ID is mapped for the second component.

2. The method of claim 1, further comprising:
detecting an integrity violation detected associated with the first component of the computing device;
wherein the determining to take the snapshot of the memory accessible to the first component is in response to the detection of the integrity violation.

3. The method of claim 1, further comprising:
in response to the determination, with the management subsystem, configuring the memory controller to treat the location IDs as read-only or read-write for the second component; and
after the configuring, executing simultaneously at least a portion of an operating system (OS) with the first component and at least a portion of a forensic analysis system with the second component, without modifying the snapshot comprising initial data stored in the initial memory locations at the time of the configuration, and with each of the first and second components attempting to access multiple of the initial physical memory locations using the location IDs.

4. The method of claim 3, further comprising:
releasing the snapshot, comprising:
configuring the memory controller to provide, for the first component, read-write access for the location IDs for which no copy-on-write mapping was created; and
for each copy-on-write mapping of one of the location IDs to an alternate memory location created for the first component:
mapping the location ID to the alternate memory location for the second component; and
freeing the initial memory location to which the location ID was previously mapped.

5. The method of claim 4, further comprising:
determining to release the snapshot in response to an indication that the forensic analysis system has completed a process of copying the data of the snapshot, stored in the initial memory locations, to secondary memory locations;
wherein the releasing is performed in response to the determining to release the snapshot.

6. The method of claim 4, further comprising:
determining to release the snapshot in response to an indication that the forensic analysis system has completed a forensic analysis of the data of the snapshot stored in the initial memory locations,
wherein the releasing is performed in response to the determining to release the snapshot.

7. A computing device comprising:
first and second hardware components to communicate using a packet-based memory fabric;
memory accessible to the first component;
a memory controller mapping location identifiers (IDs) to initial memory locations of the accessible memory; and
a management subsystem including at least one processing resource and instruction memory comprising instructions executable by the at least one processing resource to:
in response to a determination to take a snapshot of the memory accessible to the first component, configure the memory controller to treat the location IDs, mapped to initial memory locations storing initial data, as copy-on-write for the first component and read-only for the second component;
wherein the memory controller configured for copy-on-write is to:
in response to each write packet comprising information identifying the first component as a source and indicating, for a write operation, a respective one of the location IDs not already given a copy-on-write mapping, create a copy-on-write mapping of the location ID to a respective alternate memory location for the first component and write respective new data to the alternative memory location; and
in response to each read packet comprising information identifying the second component as a source and indicating, for a read operation, one of the location IDs, return initial data stored in the initial memory location to which the location ID is mapped for the second component.

8. The computing device of claim 7, wherein:
the first and second components are first and second system-on-chips (SOCs); and
the first SOC is to execute at least a portion of an operating system (OS) while the second SOC is to simultaneously execute at least a portion of a forensic analysis system, including the first and second SOCs each attempting to access multiple of the initial physical memory locations using the location IDs.

9. The computing device of claim 8, wherein:
the memory controller is to maintain the accessible memory as a mirror of a primary region of memory different than the accessible memory, using the location IDs for the accessible memory and the primary memory region;
the instructions are not to configure location IDs as copy-on-write for the first SOC for the primary region of memory in response to the determination to take the snapshot; and
when the snapshot is to be released, the instructions are to use any alternative memory locations to update mappings of the location IDs for both the accessible memory and the primary memory region.

10. The computing device of claim 7, wherein the memory controller configured for copy-on-write is to:
in response to a read packet comprising information identifying the first component as a source and indicating, for a read operation, a given one of the location IDs previously given a copy-on-write mapping, returning the respective new data stored in the respective alternate memory location to which the location ID was mapped for the first component.

11. The computing device of claim 7, further comprising:
at least one other memory controller mapping other location IDs to other initial memory locations of additional memory of the computing device that is accessible to the first component; and
the instructions further comprising instructions executable to:
in response to the determination, configure each of the at least one other memory controllers to treat the other location IDs as copy-on-write for the first component.

12. The computing device of claim 11, wherein each of the at least one other memory controllers configured for copy-on-write is to:
in response to a received write packet comprising information identifying the first component as a source and indicating, for a write operation, a respective one of the other location IDs not already given a copy-on-write mapping, create a copy-on-write mapping of the other location ID to a respective different memory location for the first component; and
in response to a received read packet comprising information identifying the second component as a source and indicating, for a read operation, the respective one of the other location IDs, return data stored in the other initial memory location to which the other location ID is mapped for the second component.

13. A system comprising:
a memory controller of a plurality of hardware components, to communicate using a packet-based memory fabric, and including first components assigned first component identifiers (CIDs) and a second component assigned a second CID, the memory controller to map location identifiers (IDs) to initial memory locations of memory accessible to the first components; and
a management subsystem comprising at least one processing resource and instruction memory comprising instructions executable by the at least one processing resource to:
in response to a determination to take a snapshot of the memory accessible to the first components, configure the memory controller to treat the location IDs as copy-on-write for sources identified by the first CIDs, respectively, and read-only for a source identified by the second CID;
wherein the memory controller configured for copy-on-write is to:
in response to a write packet comprising, for a write operation, one of the location IDs not already given a copy-on-write mapping and one of the first CIDs as a source identifier, create a copy-on-write mapping of the location ID to a respective alternate memory location for sources identified by the first CIDs; and
in response to a read packet comprising, for a read operation, one of the location IDs and the second CID as a source identifier, return data stored in the initial memory location to which the location ID is mapped for the second CID.

14. The system of claim 13, further comprising:
the hardware components, wherein the hardware components comprise:
first processor cores of a plurality of SOCs, wherein the first CIDs are assigned to the first processor cores and the first processor cores are to execute at least a portion of an operating system (OS); and
a second processor core of the plurality of SOCs, wherein the second CID is assigned to the second processor core and the second processor core is to execute at least a portion of a forensic analysis system.

15. The system of claim 13, further comprising:
the hardware components, wherein the hardware components comprise:
first processor cores of a plurality of SOCs, wherein the first CIDs are assigned to the first processor cores and the first processor cores are to execute at least a portion of an operating system (OS); and
forensic analysis circuitry to perform forensic analysis on the snapshot, wherein the second CID is assigned to the forensic analysis circuitry and the forensic analysis circuitry comprises at least one of an application-specific integrated circuit (ASIC), and a field-programmable gate array (FPGA).
